(19) United States
(12) Patent Application Publication
(10) Pub. No.: US 2017/0298466 A1
(43) Pub. Date: Oct. 19, 2017

(54) HIGH FORMABILITY SUPER STRENGTH COLD-ROLL STEEL SHEET OR STEEL STRIP, AND MANUFACTURING METHOD THEREFOR

(71) Applicant: BAOSHAN IRON & STEEL CO., LTD., Shanghai (CN)

(72) Inventors: Xiaodong Zhu, Shanghai (CN); Wei Li, Shanghai (CN); Peng Xue, Shanghai (CN)

(73) Assignee: BAOSHAN IRON & STEEL CO., LTD., Shanghai (CN)

(21) Appl. No.: 15/514,509

(22) PCT Filed: Jan. 14, 2015
(86) PCT No.: PCT/CN2015/070666

§ 371 Date: Mar. 25, 2017

(30) Foreign Application Priority Data
Sep. 26, 2014 (CN) 201410502547.1

(51) Int. Cl. C21D 9/46; C22C 38/12; C22C 38/06; C22C 38/04; C22C 38/02; C22C 38/00; C21D 6/00; C21D 8/02; C22C 38/14

(52) U.S. Cl. CPC C21D 9/46; C22C 38/14; C22C 38/12; C22C 38/06; C22C 38/04; C22C 38/02; C22C 38/002; C21D 6/005; C21D 8/0263; C21D 8/0236; C21D 8/0226; C21D 8/0205; C21D 6/008; C22C 38/001

(57) ABSTRACT

A high formability super strength cold-roll steel sheet or steel strip, and a method for manufacturing same. The steel sheet or steel strip comprises the following ingredients by weight percent: C 0.15% to 0.35%, Si 1.0% to 2.0%, Mn 1.6% to 2.6%, Mo 0.1% to 0.4%, P≦0.02%, S≦0.004%, N≦0.005%, Nb 0.015% to 0.04%, Ti 0.02% to 0.06%, Al 0.015% to 0.045%, B 0.0003% to 0.001% and B≧P %/30, and the balance being Fe and inevitable impurities. The steel sheet or steel strip has a tensile strength greater than or equal to 980 MPa, an elongation rate greater than or equal to 15% and a hole expansion rate greater than or equal to 40%, and has balanced performance.

### TECHNICAL FIELD

The present invention relates to a high formability super strength cold-roll steel sheet or steel strip, and a method for manufacturing same, and the super strength cold-roll steel sheet or steel strip not only has a better expansion rate but also has a quite good hole expansion property, and is particularly suitable for the manufacture of structural members of an automotive body.

### BACKGROUND ART

For a need of weight loss in the automobile industry, it is required to use higher strength steel sheets. Among them, super strength dual-phase steels have increasingly become a first choice in the automobile manufacturing industry, because such advanced high strength steels can effectively reduce the weight of the automotive body, thereby increasing the safety. In the automobile manufacturing process, high strength steel sheets shall not only have a good elongation rate, but also require a very high local formability, i.e., requiring a higher hole expansion rate and a bending property. Traditional cold-roll dual-phase steels have a lower yield-strength ratio, thereby possessing a certain draw forming capability; however, since the local formability is insufficient, local cracking easily occurs in the manufacture of high strength components including deformation modes such as bending and a hole expansion, so that the stamping effect on the whole parts is affected, resulting in scrapping. Document researches indicate that when the hole expansion rate and the bending property of a dual-phase steel are lower, it is often not adaptive to more rigorous forming conditions, so that the application filed is limited more substantially. High strength dual-phase steels generally contain higher levels of carbon and alloying elements; however, higher levels of carbon and alloying elements easily result in composition segregation occurring in the casting process, causing that the subsequent materials have a reduced local formability and a poor hole expansion rate and a cold bending property due to a non-homogeneous composition and structure. Banded structures, in steel, distributed in the rolling direction easily become a micro crack source, so that the local formability of the steel is further reduced.

The banded structures in the steel mainly result from composition segregation occurring in the process of molten steel solidification, wherein the contents of components in the molten steel solidified and precipitated first are different from the contents of components precipitated subsequently, the concentration of alloying elements in the molten steel will become higher and higher, finally resulting in that the alloying element contents in the firstly solidified portion of the solidified structure are greatly different from those in the subsequently solidified portion. Regions of composition segregation are deformed and elongated in the hot rolling process, and finally form banded structures. The banded structures usually contain a high level of alloying elements, and since these alloying elements are hardly diffused, it is very difficult to eliminate same; the enrichment of the alloying elements induces that carbon is also enriched in the same regions, resulting in that hard and brittle martensite in a banded distribution is formed after quenching the dual-phase steel, and is greatly harmful to the local formability, and the hole expansion property and the cold bending property are both lower, so that cracking easily occurs in the forming process. Increasing the structure homogeneity and increasing the local formability of high strength dual-phase steel are the key to obtain a balanced dual-phase steel.

US Patent US 20050167007 A1 introduces a method for manufacturing a high strength steel sheet, having chemical components: C 0.05% to 0.13%, Si 0.5% to 2.5%, Mn 0.5% to 3.5%, Cr 0.05% to 1%, Mo 0.05% to 0.6%, Al≦0.1%, S≦0.005%, N≦0.01%, P≦0.03%, and the addition of Ti 0.005% to 0.05%, Nb 0.005% to 0.05% or V 0.005% to 0.2%. The steel after undergoing hot rolling at a temperature of Ar3 or higher, coiling at 450° C. to 700° C. and annealing, then is cooled from 700° C. to 600° C. at a cooling rate of 100° C./s and quenched, and then tempered at a temperature between 180° C. and 450° C. Finally, a high strength steel having a tensile strength of 780 MPa and a hole expansion rate higher than 50% is obtained.

Japanese Patent Laid-Open No. 11-350038 introduces a 980 MPa steel having good ductility and formability, and the composition is designed to have one or more of C 0.1% to 15%, Si 0.8% to 1.5%, Mn 1.5% to 2.0%, P 0.01% to 0.05%, S≦0.005%, Sol Al 0.01% to 0.07%, N≦0.01%, Nb 0.001% to 0.02%, V 0.001% to 0.02%, and Ti 0.001% to 0.02%. Carbon equivalent=(C+Mn/6+Si/24)=0.4-0.52, and hot rolling at Ar3 or higher, coiling at 500° C. to 650° C., maintaining the temperature between Ac1 and Ac3, cooling to 580° C. to 720° C., rapidly cooling to room temperature, and then ageing at 230° C. to 300° C.

Chinese Patent No. 200810119823.0 introduces a method for manufacturing a 980 MPa dual-phase steel having C 0.14% to 0.21%, Si 0.4% to 0.9%, Mn 1.5% to 2.1%, P≦0.02%, S≦0.01%, Nb 0.001% to 0.05%, and V 0.001% to 0.02%, wherein after hot rolling and cold rolling, the temperature is maintained between 760° C. and 820° C., the cooling rate is 40-50° C./s, and overageing is carried out at 240-320° C. for 180 s to 300 s.

The above-mentioned patents mostly relate to 980 MPa grade high strength steels, and some inventions relate to common dual phase steels characterized by having advantages of a low yield, a moderate elongation rate and a good drawability; and some invention relates to a higher hole expansion rate; however, when the high hole expansion rate is obtained, a design of a higher yield-strength ratio is used, but the drawability is insufficient; although the hole expansion rate is very high, since the drawability is insufficient, it is not suitable for formations with higher drawability requirements, and the performance also falls out of the range of balanced performance. Many application fields of high strength steels have higher requirements of both drawability and hole expansion property, and if merely the drawability is good, but the hole expansion property is poor, or if the hole expansion property is good, but the drawability is poor, then the application field is more limited.

### DISCLOSURE OF THE INVENTION

An object of the present invention is to provide a high formability super strength cold-roll steel sheet or steel strip and a method for manufacturing same, the super strength cold-roll steel sheet or steel strip having a tensile strength greater than or equal to 980 MPa, a product of strength and elongation, i.e., the tensile strength×the elongation rate, greater than or equal to 17000 and a hole expansion rate greater than or equal to 45%, a balanced performance and a thickness ranging between 0.8 mm and 2.3 mm. The characteristics of the steel are a homogeneous structure distribution, a small difference of hardness between various phases, and the main structures in the steel include ferrite, bainite, martensite and residual austenite. No carbide is precipitated from the bainite in the steel, or only fine carbides are precipitated in the inside of the bainite, without any carbide precipitated at an interface. In the aspect of performance, as compared to other cold-roll steel sheets of the same grade, the steel has a higher elongation rate, a better hole expansion rate or a lower yield-strength ratio, i.e., having more balanced mechanical properties, and is particularly suitable for the formation of various automotive safety parts.

In order to achieve the above-mentioned object, the technical solution of the present invention is as follows:

with regard to the characteristic that the formation of a high strength steel not only requires a good drawability but also requires a good hole expansion property, after proper composition design and process design, the steel of the present invention can have good comprehensive mechanical properties including a higher elongation rate, a lower yield-strength ratio and a lower hole expansion rate, is obviously advantageous in terms of at least one property as compared to steels of the same grade, and thus has an advantage of balanced performance.

A higher carbon content design+higher Si content design as compared to general 980 MPa-grade high strength steels and an equivalent or slightly higher Mn content design as compared to general 980 MPa-grade high strength steels are used in the present invention. The designs of C, Si and Mn form the basis of the composition design of the present invention: since the C content is significantly higher than that in general 980 MPa-grade high strength steels, under the combined action of Si, Mn and process, it is easy to obtain a higher level of residual austenite, thereby giving a higher elongation rate. Moreover, the high silicon design cooperated with a rational process not only facilitates obtaining more residual austenite, but also facilitates the diffusion of C from the bainite to the austenite, thereby reducing the carbon content of the bainite, thus facilitating achieving that no carbide is precipitated inside the bainite or only fine carbides are precipitated, without any carbide precipitated at an interface. The presence of the residual austenite in a large quantity facilitates the diffusion of C from the martensite to the austenite, which not only increases the stability of the residual austenite but also reduces the carbon content of the martensite, thereby reducing the hardness of the martensite, which is more beneficial to the drawability and the hole expansion property. The use of a moderate content of manganese, ensuring the quenching performance, together with element carbon is a main assurance of forming the steel strength; moreover, such a design of Mn range and such a design of Si and C can facilitate the preferential formation of austenite, further increase the content of the austenite, and are beneficial to the increase of ductility. With the design of such high C, Si and Mn contents, an extremely low yield-strength ratio and a high elongation rate, but a lower hole expansion rate, can be obtained.

In order to eventually obtain the balanced performance of a low yield, a high elongation rate and a high hole expansion rate of the present invention, alloying elements and micro alloy elements such as Mo, B, Ti, Nb are further added to the steel of the present invention. The addition of element molybdenum on one hand increases the strength of the steel, and on the other hand facilitates, in the hot rolling procedure, molybdenum and titanium to form slight precipitation, preferably inter-phase precipitation, using the designed process, and these precipitates in ferrite grains can increase the hardness of the ferrite, reduces the difference of hardness between soft and hard phases, but do not substantially reduce the elongation rate. The addition of a trace amount of zirconium refines the original austenite grains, and decreases the concentration of impurity elements at a grain boundary. The addition of B improves the segregation tendency of P at the grain boundary. There is further improved effect on the plasticity and toughness of the super strength steel. Ti and Nb not only can have a conventional effect of grain refining, but also can have a combined action together with Mo to form inter-phase dispersive precipitation, which is more beneficial to the structure homogeneity and the increase of hole expansion rate, and has a small effect on the decrease of elongation rate.

In particular, the high formability super strength cold-roll steel sheet or steel strip of the present invention comprises the following ingredients by weight percent: C 0.15% to 0.35%, Si 1.0% to 2.0%, Mn 1.6% to 2.6%, Mo 0.1% to 0.4%, P≦0.02%, S≦0.004%, N≦0.005%, Nb 0.015% to 0.04%, Ti 0.02% to 0.06%, Al 0.015% to 0.045%, B 0.0003% to 0.001% and B≧P %/30, and the balance being Fe and inevitable impurities.

Preferably, the steel of the present invention comprises the following ingredients by weight percent: C 0.17% to 0.32%, Si 1.2% to 1.8%, Mn 1.8% to 2.5%, Mo 0.15% to 0.4%, P≦0.012%, S≦0.002%, N≦0.005%, Nb 0.015% to 0.04%, Ti 0.02% to 0.06%, Al 0.015% to 0.045%, B 0.0003% to 0.001% and B≧P %/30, and the balance being Fe and inevitable impurities.

Further, the composition of the steel of the present invention may further comprise by weight percent: Zr 0.005% to 0.015%.

The super strength cold-roll steel sheet or steel strip of the present invention has a tensile strength greater than or equal to 980 MPa, a product of strength and elongation, i.e., the tensile strength×the elongation rate, greater than or equal to 17000 and a hole expansion rate greater than or equal to 45%.

The super strength cold-roll steel sheet or steel strip of the present invention has the structure characteristics: a ferrite grain diameter of less than or equal to 10 microns, and a main structures of ferrite, bainite, martensite and 10% or less by volume percent of retained austenite.

In the composition design of the steel of the present invention:

C: This element increases the strength of the steel, increases the hardness of the martensite, facilitates the enrichment of carbon in the austenite, and facilitates the formation of the retained austenite. Therefore, the carbon content is chosen between 0.15% and 0.35%, wherein if the content is lower than 0.15%, the strength will be affected, and the amount and stability of the resulting austenite will be reduced; and if the content is higher than 0.35%, an over high hardness of martensite will be caused, which is adverse to the hole expansion rate, and if the over high carbon equivalent affects the weldability, thereby limiting the application.

Si: This element plays a role of increasing the elongation rate in the steel. Si also substantially affects the structure of the steel, and facilitates the purification of the ferrite and the formation of the retained austenite. If the content is lower than 0.8%, the amount of the resulting residual austenite will be lower, which affects the elongation rate of the steel; and if the content is higher than 2.0%, other metallurgical quality defects will be brought about, and under the premise of the design of the present invention, it is not quite necessary.

Mn: This element can increase the hardenability of the steel, and effectively increase the strength of the steel. The Mn content is chosen to be 1.6% to 2.6%, wherein if the content is lower than 1.6%, the strength of the steel will be insufficient, and the mechanism of facilitating the preferential formation of residual austenite will hardly work; and if the content is higher than 2.6%, the strength will be too high, and segregation also easily occurs.

The effect of the comprehensive addition of C, Si and Mn: with the design of high C+Si+Mn, particularly a higher level of C content, the formation of a higher level of residual austenite can be facilitated, to obtain properties of a low yield and a high elongation rate, and reference can be made to the description hereinabove for details.

Mo: This element can increase the hardenability of the steel, and effectively increase the strength of the steel; Mo improves the distribution of carbides, and can, in cooperation with a proper hot rolling process, form inter-phase precipitation together with Ti, which benefits the increase of the hardness of the ferrite, the improvement of the structure homogeneity and the increase of the hole expansion rate. 0.1% to 0.4% of Mo is added, wherein if lower than 0.1% of Mo is added, the effect will be not obvious, and the density of carbide precipitation is insufficient, and if the content is higher than 0.4%, the yield strength will be too high.

Ti: This element, in a content of 0.02% to 0.0.4%, plays a role of nitrogen fixing and grain refining, wherein under a combined action of Ti and Mo, composite carbides are precipitated, and especially when appropriate in a hot rolling process, diffused fine inter-phase precipitation can be obtained, so that the hardness of the ferrite is effectively increased; moreover, coarsening does not easily occur, and the hole expansion rate can be better improved.

B: This element can increase the hardenability of the steel, and effectively increase the strength of the steel; The added amount of B in the present invention is lower, and is mainly used for alleviating a tendency of intergranular segregation of P; therefore, it is required that B 0.0003% to 0.001%, with B≧P %/30, the content of B being associated with the content of P, wherein when the content of P is higher, the content of B is higher, which is beneficial for avoiding the intergranular segregation of P. When the content of P is lower, the content of B is correspondingly reduced, because a higher level of B will substantially affect the strength.

Zr: This element, in a content of 0.0005% to 0.015%, refines the original austenite grains, and decreases the concentration of intergranular impurity elements.

P: It is an impurity element in the steel, and is required to be ≦0.02%.

S: This element, as an impurity element in the steel, forms MnS which severely affects the hole expansion rate, and is required to be ≦0.004%.

Al: This element plays a role of deoxygenation and grain refining, and is required to be Al: 0.015% to 0.045%.

N: It is an impurity element in the steel, and is required to be ≦0.005%. An over high level of N easily results in cracks or bubbles on the slab surface.

Nb: This element, as a precipitation enhancing element, plays a role of grain refining and strength adjustment, and is required to be distributed between 0.02% and 0.04%, wherein if the content is too low, there will be no obvious enhancement on strength, and if the content is too high, the plasticity will be reduced more substantially. Nb refines grains and has some benefits to the structure homogeneity.

The present invention aims to reduce the macro segregation and microsegregation of S and P in the steel, in terms of manufacturing process. More rapid cooling is used in the continuous casting process, the water spray amount per kilogram of steel is ≧0.65 litres of water in order to refine the as-cast structure and alleviate the degree of local segregation, and the water spray ending temperature is ≦800° C. This process is beneficial for obtaining a homogeneous as-cast structure. In the hot rolling process, heating is further carried out at 1100° C. to 1250° C., and after finish rolling at Ar3 or higher, a cooling mode of first air cooling and then water cooling is used, to ensure that there is a slow cooling holding time at a temperature between 700° C. and 800° C., so as to obtain regularly arranged fine precipitated phases resulting from inter-phase precipitation. In annealing, a holding temperature of Ac3+30° C. or higher is used, and a higher primary cooling temperature and a higher starting temperature of rapid cooling are used, so as to limit a too high formation amount of ferrite or a too sufficient of the redistribution of C in a high-temperature region, so that a lower hardness caused by too much or too soft ferrite phase is avoided. The rapid cooling requires cooling to a temperature between 200° C. and 400° C. at a cooling rate of 40-120° C./s, so as to ensure a necessary strength; and tempering at a temperature between 200° C. and 400° C. to give an opportunity of forming the retained austenite and the bainite. The final product has a good elongation rate and a hole expansion rate, and thus has a good formability.

The method for manufacturing the high formability super strength cold-roll steel sheet or steel strip of the present invention comprises the following steps:

1) Smelting and Casting

smelting and casting according to the above-mentioned composition, with rapid cooling used for the continuous casting slab, wherein the water spray amount per kilogram of steel is ≧0.65 litres of water, and the water spray ending temperature is ≦800° C.;

2) Hot Rolling

heating at 1100° C. to 1250° C., holding the temperature for a time of 0.6 hours or more, hot-rolling at a temperature of Ar3 or higher, after the rolling, firstly air cooling, maintaining a slow cooling state at a temperature between 700° C. and 800° C. for 5 s or more, and then rapidly cooling, the coiling temperature being 500° C. to 600° C.;

3) Cold-rolling at a reduction rate of 40% to 65%; and

4) Annealing

holding a temperature at 820° C. to 880° C., cooling to a starting temperature of rapid cooling at v1=5-20° C./s with the starting temperature of rapid cooling being ≧820-10×v1, rapidly cooling to 200° C. to 450° C. at a rate of 40-120° C./s, tempering at 250° C. to 450° C. for 100 s to 400 s, and then further performing 0% to 0.3% temper rolling.

Preferably, with rapid cooling used for the continuous casting slab, the water spray amount per kilogram of steel is ≧0.7 litres of water, and the water spray ending temperature is ≦800° C.

Preferably, the hot rolling process of step 2) comprises heating at 1100° C. to 1200° C., holding the temperature for a time of 0.8 hours to 1.2 hours, hot-rolling at a temperature of Ar3 or higher, after the rolling, firstly air cooling, maintaining a slow cooling state at a temperature between 700° C. and 800° C. for 10 s or more, and then rapidly cooling, the coiling temperature being 500° C. to 600° C.

Preferably, the annealing procedure of step 4) comprises maintaining a temperature at 830° C. to 860° C., cooling to a starting temperature of rapid cooling at v1=5-20° C./s with the starting temperature of rapid cooling being ≧820-10×cooling rate v1, cooling to 240° C. to 400° C. at a rate of 40-120° C./s, annealing at 270° C. to 400° C. for 100 s to 400 s, and then further performing 0% to 0.3% temper rolling.

The process for manufacturing the super strength cold-roll dual-phase steel of the present invention is as follows:

in the smelting and casting process of the present invention, required alloying composition is obtained, and the contents of S and P are reduced as far as possible; and rapid cooling is used for the continuous casting slab, to reduce the segregation as far as possible: the water spray amount per kilogram of steel is ≧0.65 litres of water in order to refine the as-cast structure and alleviate the degree of local segregation, and the water spray ending temperature is ≦800° C.

In the annealing procedure, the temperature is held at 820° C. to 880° C., a higher soaking temperature, aiming to obtain a more homogeneous structure, and cooling is carried out to reach a starting temperature of rapid cooling at v1=5-20° C./s. The starting temperature of rapid cooling being ≧820-10×v1. Namely, the value of the starting temperature of rapid cooling is related to the cooling rate V1, wherein if the cooling rate V1 is greater, less ferrite phase will be formed, and the diffusion of C is limited, so that the starting temperature of rapid cooling can be slightly lower. If the V1 is lower, the ferrite phase will be easily formed, and also easily softened, so that the starting temperature of rapid cooling must be high. Rapid cooling is carried out to reach 200° C. to 450° C. at a rate of 40-120° C./s, and after annealing at 250° C. to 450° C. for 100 s to 400 s, 0% to 0.3% temper rolling is then further performed. The rapid cooling ensures a sufficient strength, and the tempering stage ensures the formation of the residual austenite and the bainite. The temper rolling ensures a necessary sheet shape.

The thickness of the super strength cold-roll steel sheet or steel strip of the present invention is 0.8 mm to 2.3 mm

The performance characteristics of the super strength cold-roll steel sheet or steel strip of the present invention are as follows: a tensile strength greater than or equal to 980 MPa, a high ductility (a product of strength and elongation, i.e., the tensile strength×the elongation rate, greater than or equal to 17000), a high hole expansion rate (a hole expansion rate greater than or equal to 45%), and due to the characteristic of having a high drawability and a high hole expansion rate, there is a balanced performance, which is particularly suitable for the formation of high strength automobile parts. The structure characteristics of the steel are as follows: the structure is fine and homogeneous, the ferrite grain diameter is less than or equal to 10 microns, and the main structures contained in the steel are ferrite, bainite, martensite and 10% or less by volume percent of residual austenite. The ferrite grains are uniformly distributed in the steel, and the bainite is precipitated in a form of short strips without any precipitation of carbides between the bainite strips. The residual austenite is dispersed in gaps between the bainite strips or between the ferrite grains. The martensite is distributed in the structure in a dispersed manner.

The beneficial effects of the present invention are as follows:

compared with the prior art, the steel of the present invention has a very high strength and a good formability, the elongation rate and the hole expansion rate are both very excellent, the steel has a tensile strength greater than or equal to 980 MPa, a high ductility (a product of strength and elongation, i.e., the tensile strength×the elongation rate, greater than or equal to 17000), a high hole expansion rate (a hole expansion rate greater than or equal to 45%), and due to the characteristic of having a high drawability and a high hole expansion rate, a balanced performance of strength, elongation rate and hole expansion rate is achieved, which is particularly suitable for the formation of high strength automobile parts, and well adapts to the need of manufacturing various automobile parts.

### PARTICULAR EMBODIMENTS OF THE INVENTION

The present invention is further described below in conjunction with embodiments.

Table 1 is the chemical composition of an embodiment of the steel of the present invention, the process for manufacturing the embodiment of the steel of the present invention is as shown in table 2, and the strength of the steel of the present invention obtained after smelting, hot rolling, cold rolling, annealing and temper rolling is as shown in table 3.

It can be seen from table 3 that a super strength cold-roll steel sheet or steel strip having a strength of 980 MPa or higher can be manufactured according to the present invention, and has a good elongation and a good hole expansion rate. It is different from and superior to the existing inventions in terms of various aspects such as a composition design, resource saving, a degree of manufacturing difficulty, and final results.

TABLE 1
Chemical composition of the steel of the present invention (wt %)

| Embodiment | C | Si | Mn | Mo | Zr | P | S | Al | N | Nb | Ti | B |
|---|---|---|---|---|---|---|---|---|---|---|---|---|
| A1 | 0.15 | 1.0 | 1.8 | 0.10 | 0.005 | 0.008 | 0.005 | 0.015 | 0.005 | 0.035 | 0.04 | 0.0003 |
| A2 | 0.18 | 2.0 | 1.6 | 0.15 | 0.010 | 0.015 | 0.004 | 0.040 | 0.004 | 0.030 | 0.03 | 0.0006 |
| A3 | 0.2 | 1.7 | 2.0 | 0.18 | 0.015 | 0.010 | 0.003 | 0.030 | 0.003 | 0.025 | 0.02 | 0.004 |
| A4 | 0.24 | 1.6 | 2.2 | 0.35 | 0.020 | 0.012 | 0.001 | 0.025 | 0.0025 | 0.02 | 0.025 | 0.0008 |
| A5 | 0.28 | 1.8 | 2.4 | 0.40 | 0.018 | 0.006 | 0.002 | 0.045 | 0.0015 | 0.015 | 0.05 | 0.0009 |
| A6 | 0.30 | 1.4 | 2.6 | 0.22 | | 0.010 | 0.001 | 0.025 | 0.0025 | 0.02 | 0.025 | 0.0005 |
| A7 | 0.32 | 1.2 | 2.1 | 0.25 | 0.007 | 0.018 | 0.002 | 0.023 | 0.0045 | 0.04 | 0.035 | 0.001 |
| A8 | 0.35 | 0.8 | 1.7 | 0.3 | 0.012 | 0.02 | 0.0015 | 0.027 | 0.0035 | 0.018 | 0.06 | 0.0007 |

TABLE 2

| | | | Inlet | | | | | |
|---|---|---|---|---|---|---|---|---|
| | | Primary | temperature | Outlet | Rapid | | | |
| | Holding | cooling | of | temperature | cooling | Tempering | | Temper- |
| | temperature | rate | rapid | of rapid | Rate | Temperature | Tempering | rolling |
| Embodiment | ° C. | ° C./s | cooling ° C. | cooling ° C. | ° C./s | ° C. | Times | rate % |
| A1 | 830 | 5 | 770 | 200 | 120 | 270 | 100 | 0.1 |
| A2 | 840 | 7 | 750 | 250 | 80 | 300 | 150 | 0.2 |
| A3 | 850 | 10 | 730 | 300 | 60 | 320 | 200 | 0.3 |
| A4 | 860 | 15 | 740 | 350 | 40 | 350 | 250 | 0 |
| A5 | 855 | 20 | 720 | 400 | 70 | 420 | 300 | 0.15 |
| A6 | 870 | 25 | 740 | 450 | 90 | 450 | 350 | 0.25 |
| A7 | 835 | 18 | 745 | 380 | 100 | 400 | 400 | 0.3 |
| A8-1 | 840 | 13 | 760 | 320 | 110 | 370 | 320 | 0.1 |
| A8-2 | 880 | 15 | 750 | 350 | 100 | 350 | 250 | 0.1 |

TABLE 3

| | | | | Hole expansion |
|---|---|---|---|---|
| Embodiment | σₛMpa | σ_{b}Mpa | δ▴ % | rate % |
| A1 | 640 | 1040 | 18 | 45 |
| A2 | 680 | 1090 | 21 | 50 |
| A3 | 750 | 1120 | 18 | 54 |
| A4 | 800 | 1150 | 18 | 55 |
| A5 | 850 | 1180 | 16 | 55 |
| A6 | 900 | 1270 | 14 | 51 |
| A7 | 960 | 1320 | 13 | 60 |
| A8-1 | 1050 | 1430 | 12 | 65 |
| A8-2 | 1040 | 1410 | 13 | 60 |

1. A high formability super strength cold-roll steel sheet or steel strip, comprising the following ingredients by weight percent: C 0.15% to 0.35%, Si 1.0% to 2.0%, Mn 1.6% to 2.6%, Mo 0.1% to 0.4%, P≦0.02%, S≦0.004%, N≦0.005%, Nb 0.015% to 0.04%, Ti 0.02% to 0.06%, Al 0.015% to 0.045%, B 0.0003% to 0.001% and B≧P %/30, and the balance being Fe and inevitable impurities.

2. The high formability super strength cold-roll steel sheet or steel strip of claim 1, characterized by comprising the following ingredients by weight percent: C 0.17% to 0.32%, Si 1.2% to 1.8%, Mn 1.8% to 2.5%, Mo 0.15% to 0.4%, P≦0.012%, S≦0.002%, N≦0.005%, Nb 0.015% to 0.04%, Ti 0.02% to 0.06%, Al 0.015% to 0.045%, B 0.0003% to 0.001% and B≧P %/30, and the balance being Fe and inevitable impurities.

3. The high formability super strength cold-roll steel sheet or steel strip of claim 1 further comprising by weight percent: Zr 0.005% to 0.015%.

4. The high formability super strength cold-roll steel sheet or steel strip of claim 1, characterized in that said super strength cold-roll steel sheet or steel strip has a tensile strength greater than or equal to 980 MPa, a product of strength and elongation, i.e., tensile strength×elongation rate, greater than or equal to 17000 and a hole expansion rate greater than or equal to 45%.

5. The high formability super strength cold-roll steel sheet or steel strip of claim 1, characterized in that said super strength cold-roll steel sheet or steel strip has the structure characteristics: a ferrite grain diameter of less than or equal to 10 microns, and a main structures of ferrite, bainite, martensite and 10% or less by volume percent of residual austenite.

6. A method for manufacturing the high formability super strength cold-roll steel sheet or steel strip of claim 1, comprising the following steps:
1) Smelting and casting
smelting and casting according to the composition in claim 1, and rapid cooling the continuous casting slab, wherein the water spray amount per kilogram of steel is ≧0.65 litres of water, and the water spray ending temperature is ≦800° C.;
2) Hot rolling
heating at 1100° C. to 1250° C., holding the temperature for a time of 0.6 hours or more, hot-rolling at a temperature of Ar3 or higher, after the rolling, firstly air cooling, maintaining a slow cooling state at a temperature between 700° C. and 800° C. for 5 s or more, and then rapidly cooling, the coiling temperature being 500° C. to 600° C.;
3) Cold-rolling at a reduction rate of 40% to 65%; and
4) Annealing
holding a temperature at 820° C. to 880° C., cooling to a starting temperature of rapid cooling at v1=5-20° C./s with the starting temperature of rapid cooling being ≧820-10×v1, rapidly cooling to 200° C. to 450° C. at a rate of 40-120° C./s, tempering at 250° C. to 450° C. for 100 s to 400 s, and then further performing 0% to 0.3% temper rolling.

7. The method for manufacturing the high formability super strength cold-roll steel sheet or steel strip of claim 6, characterized in that rapid cooling is used for the continuous casting slab, the water spray amount per kilogram of steel is ≧0.7 litres of water, and the water spray ending temperature is ≦800° C.

8. The method for manufacturing the high formability super strength cold-roll steel sheet or steel strip of claim 6, characterized in that in the hot rolling procedure of step 2), heating at 1100° C. to 1250° C., holding the temperature for a time of 0.8 hours to 1.2 hours, hot-rolling at a temperature of Ar3 or higher, after the rolling, firstly air cooling, maintaining at a slow cooling state at a temperature between 700° C. and 800° C. for 10 s or more, and then rapidly cooling, the coiling temperature being 500° C. to 600° C.

9. The method for manufacturing the high formability super strength cold-roll steel sheet or steel strip of claim 6, characterized in that in the annealing procedure of step 4), holding a temperature at 830° C. to 860° C., cooling to a starting temperature of rapid cooling at v1=5-20° C./s with the starting temperature of rapid cooling being ≧820-10×cooling rate v1, cooling to 240° C. to 400° C. at a rate of 40-120° C./s, tempering at 270° C. to 400° C. for 100 s to 400 s, and then further performing 0% to 0.3% temper rolling.

10. The method for manufacturing the high formability super strength cold-roll steel sheet or steel strip of claim 6, characterized in that the composition of said super strength cold-roll steel sheet or steel strip further comprises by weight percent: Zr 0.005% to 0.015%.

11. The method for manufacturing the high formability super strength cold-roll steel sheet or steel strip of claim 6, characterized in that the thickness of said super strength cold-roll steel sheet or steel strip is 0.8 mm to 2.3 mm.

12. The method for manufacturing the high formability super strength cold-roll steel sheet or steel strip of claim 6, characterized in that said super strength cold-roll steel sheet or steel strip has a tensile strength greater than or equal to 980 MPa, a product of strength and elongation, i.e., the tensile strength×the elongation rate, greater than or equal to 17000 and a hole expansion rate greater than or equal to 45%.

13. The method for manufacturing the high formability super strength cold-roll steel sheet or steel strip of claim 6, characterized in that said super strength cold-roll steel sheet or steel strip has the structure characteristics: a ferrite grain diameter of less than or equal to 10 microns, and a main structures of ferrite, bainite, martensite and 10% or less by volume percent of residual austenite.

14. The method for manufacturing the high formability super strength cold-roll steel sheet or steel strip of claim 10, characterized in that the thickness of said super strength cold-roll steel sheet or steel strip is 0.8 mm to 2.3 mm.

15. The method for manufacturing the high formability super strength cold-roll steel sheet or steel strip of claim 10, characterized in that said super strength cold-roll steel sheet or steel strip has a tensile strength greater than or equal to 980 MPa, a product of strength and elongation, i.e., the tensile strength×the elongation rate, greater than or equal to 17000 and a hole expansion rate greater than or equal to 45%.

16. The method for manufacturing the high formability super strength cold-roll steel sheet or steel strip of claim 10, characterized in that said super strength cold-roll steel sheet or steel strip has the structure characteristics: a ferrite grain diameter of less than or equal to 10 microns, and a main structures of ferrite, bainite, martensite and 10% or less by volume percent of residual austenite.

17. The method for manufacturing the high formability super strength cold-roll steel sheet or steel strip of claim 11, characterized in that said super strength cold-roll steel sheet or steel strip has a tensile strength greater than or equal to 980 MPa, a product of strength and elongation, i.e., the tensile strength×the elongation rate, greater than or equal to 17000 and a hole expansion rate greater than or equal to 45%.

18. The method for manufacturing the high formability super strength cold-roll steel sheet or steel strip of claim 11, characterized in that said super strength cold-roll steel sheet or steel strip has the structure characteristics: a ferrite grain diameter of less than or equal to 10 microns, and a main structures of ferrite, bainite, martensite and 10% or less by volume percent of residual austenite.

19. The method for manufacturing the high formability super strength cold-roll steel sheet or steel strip of claim 12, characterized in that said super strength cold-roll steel sheet or steel strip has the structure characteristics: a ferrite grain diameter of less than or equal to 10 microns, and a main structures of ferrite, bainite, martensite and 10% or less by volume percent of residual austenite.
